(19) United States
(12) Patent Application Publication
(10) Pub. No.: US 2020/0208339 A1
(43) Pub. Date: Jul. 2, 2020

(54) IMPROVEMENTS TO DRYING TEXTILES

(71) Applicant: Cares Laboratory Limited, Barnsley (GB)

(72) Inventors: Thomas James ABBEY, Newton Kyme (GB); David John TOMS, Bromley (GB); Alex Georgia BUTCHER, Barnsley (GB)

(21) Appl. No.: 16/612,708

(22) PCT Filed: May 14, 2018
(86) PCT No.: PCT/GB2018/051299

§ 371 Date: Nov. 11, 2019

(30) Foreign Application Priority Data
May 19, 2017 (GB) 1708040.9

(51) Int. Cl. D06F 58/26; B32B 5/02; B32B 5/24; B32B 7/12; B32B 1/00; B32B 37/12; B32B 15/04; B32B 15/14; B32B 15/20; B32B 37/16; D06F 58/02

(52) U.S. Cl. CPC D06F 58/26; B32B 2509/00; B32B 5/24; B32B 7/12; B32B 1/00; B32B 37/12; B32B 15/04; B32B 15/14; B32B 15/20; B32B 37/16; D06F 58/02; B32B 2262/0284; B32B 2262/062; B32B 2311/24; B32B 2037/1253; B32B 2307/30; B32B 5/022

(57) ABSTRACT

The present invention provides a heat reflective sheet (100) to improve the drying performance of a tumble dryer, comprising a substantially sheet-like substrate (110) and a heat reflective layer (120,122) located on at least one outer surface (112,114) of the substrate. A method of manufacturing a heat reflective sheet to improve the drying performance of a tumble dryer is also provided, comprising providing a substantially sheet-like substrate (110) and locating a heat reflective layer (120,122) on at least one outer surface (112,114) of the substrate.

The present invention relates to dryers for removing moisture from textiles. In particular, but not exclusively, the present invention relates to a device for use in a tumble dryer to reduce the time and energy required to dry at least one textile article located in the tumble dryer.

A clothes dryer, often known as a ‘tumble dryer’, is a powered appliance for domestic or industrial use to remove moisture from items of clothing and/or other textile articles typically shortly after being subjected to a wash cycle in a washing machine. Conventional dryers typically include a rotating drum called a ‘tumbler’ through which heated air is circulated to evaporate the moisture held in the textile article. The drum is rotated to maintain a space between the articles being dried and increase the efficiency of the drying process. The hot, humid air is usually vented to atmosphere to allow additional dry, heated air to enter the drum and continue the drying process until the textile article is substantially moisture free and dry or alternatively the water is extracted by an internal condenser and the extracted water collected in a reservoir to be subsequently emptied by the user.

However, conventional clothes dryers are particularly inefficient and require significant amounts of time and energy to fully dry a textile article. Over-drying is also a common occurrence which wastes further time and energy. The environmental impact of clothes dryers is particularly severe in the US and Canada where over 80% of all homes have a clothes dryer.

It is an aim of certain embodiments of the present invention to provide a device and method that substantially increases the efficiency of tumble dryer in terms of time and energy, without imparting chemicals or deposits onto a textile article being dried and/or into the atmosphere during the drying process.

It is an aim of the certain embodiments of the present invention to provide a device and method that significantly reduces the amount of time and energy required for a domestic or industrial tumble dryer to dry a textile article.

It is an aim of certain embodiments of the present invention to provide a single use or re-usable device which allows a tumble dryer to efficiently and effectively dry a textile article, such as an item of clothing.

It is an aim of certain embodiments of the present invention to provide a device that decreases the amount of time and energy required for a tumble dryer to dry at least one textile article, whilst ensuring the textile article/s remains moving with respect to the drum and aerated during the drying process.

According to a first aspect of the present invention there is provided a device to improve the drying performance of a tumble dryer, comprising:
a substantially sheet-like substrate; and
a heat reflective layer located on at least one surface of the substrate.

Optionally, the device has a thickness of at least around 0.05 mm.

Optionally, the thickness is between around 0.1 mm and 1.5 mm.

Optionally, the or each heat reflective layer has a thickness of around 0.01 mm to around 0.5 mm.

Optionally, the or each heat reflective layer has a surface area of at least around 6000 mm².

Optionally, the device has a maximum dimension across its profile of around 300 mm.

Optionally, the substrate comprises at least one layer of a non-woven material.

Optionally, the non-woven material comprises polyethylene terephthalate and/or cellulose.

Optionally, the substrate has a weight of around 40 to 120 gsm.

Optionally, the substrate has a weight of around 80 gsm.

Optionally, the heat reflective layer comprises a metallic material.

Optionally, the heat reflective layer comprises aluminium.

Optionally, the heat reflective layer comprises a layer of gold aluminium foil.

Optionally, a heat reflective layer is located on both surfaces of the substrate.

Optionally, the or each heat reflective layer is adhered to the substrate by an adhesive.

Optionally, the device has a substantially polygonal or curved peripheral profile.

According to a second aspect of the present invention there is provided a use of a device according to the first aspect of the present invention to improve the drying performance of a tumble dryer.

According to a third aspect of the present invention there is provided a method of manufacturing a device to improve the drying performance of a tumble dryer, comprising:
providing a substantially sheet-like substrate; and
locating a heat reflective layer on at least one surface of the substrate.

Optionally, the method further comprising applying an adhesive to the at least one surface of the substrate prior to locating the heat reflective layer thereon.

Optionally, the method further comprises curing the adhesive at a predetermined temperature for a predetermined time.

Optionally, the predetermined temperature is around 150° C.

Optionally, the predetermined time is around 1 to 2 minutes.

Optionally, locating comprises locating a heat reflective layer to both surfaces of the substrate.

Optionally, a thickness of the device is at least 0.05 mm.

Optionally, the method further comprises providing the device with a substantially polygonal or curved peripheral profile.

Optionally, the substrate comprises a non-woven material.

Optionally, the non-woven material comprises polyethylene terephthalate and/or cellulose.

Optionally, the or each heat reflective layer comprises a metallic material.

### DESCRIPTION OF THE DRAWINGS

Certain embodiments of the present invention will now be described with reference to the accompanying drawings in which:

FIG. 1 illustrates an exploded schematic showing the different layers of a heat reflective device according to certain embodiments of the present invention;

Table 1 includes a first set of test results associated with different heat reflective devices according to certain embodiments of the present invention; and

Table 2 includes a further set of test results associated with different heat reflective devices according to certain embodiments of the present invention.

### DETAILED DESCRIPTION

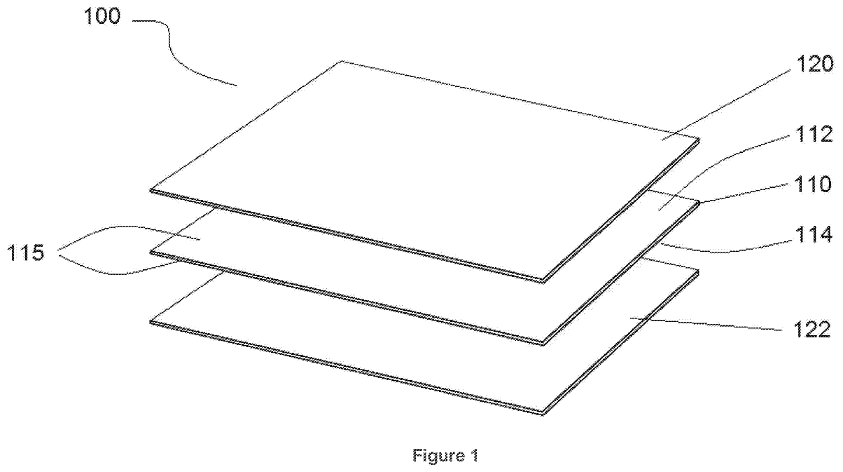

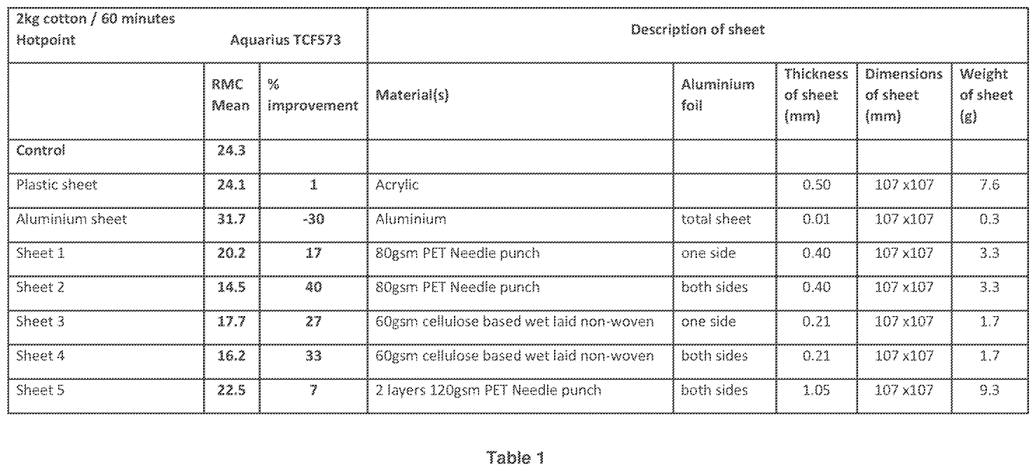

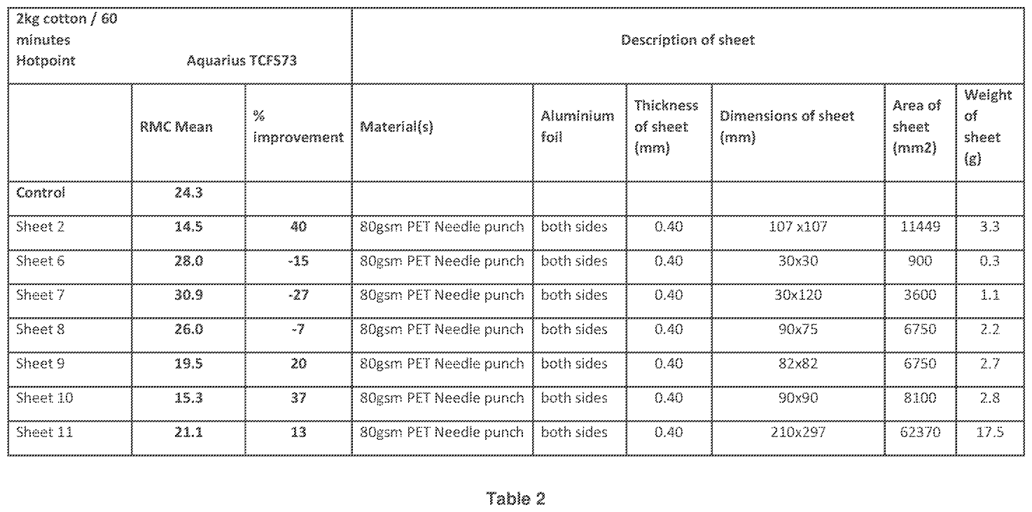

As illustrated in the FIG. 1, a device 100 according to certain embodiments of the present invention includes a non-woven fabric carrier layer or substrate 110 which has a first surface 112 and an opposed second surface 114. A hot-melt adhesive 115 is applied to both surfaces 112,114. A heat reflective layer 120,122 having a heat reflective outer surface is disposed on each layer of adhesive 112 to thereby provide a layered/laminated and substantially sheet-like device 100 having radiant heat reflective properties in accordance with certain embodiments of the present invention. Alternatively, an adhesive and a heat reflecting layer may be applied to only one side of the carrier layer 110, and optionally the other side may also include a layer of adhesive to seal and waterproof the carrier layer particularly if the same is made from a water absorbent material.

It will be understood that the term ‘layer’ for the heat reflective layer includes a coating, film, or the like.

The carrier layer 110 is aptly a non-woven fabric material, such as cellulose, polyester, polypropylene, polyurethane, or the like, made by a dry-laying, wet-laying, spun-bonded, or spun-laced process. A wet laid non-woven material may be desirable in view of its dimensional stability when wet and when stretched as it is pulled through the layer/coating application machine. A suitable non-woven material is 80 gsm 100% polyester needle punch non-woven fabric (BRN081080C Ahlstrom). Alternatively, the carrier layer 110 may be a woven material and/or may comprise a plastic or polymer (synthetic) material, e.g. polyethylene terephthalate (PET) film, or the like. The carrier layer, i.e. substrate, may be manufactured by moulding, extrusion, casting or the like.

Aptly, the material of the carrier layer 110 is sufficiently absorbent so the adhesive can sink in to the same to provide an effective bond to the foil layer/s. Aptly the material of the carrier layer is heat resistant so the device 100 survives the manufacturing process and a tumble drying cycle in use without melting or partially melting. Aptly, the carrier layer in particular has a sufficient tensile strength to be pulled through the coating machinery during production without splitting. Aptly, the carrier layer is not, or is only partially, elastic such that the non-woven does not overly stretch during the manufacturing process, especially when wet with the hot melt adhesive—this ‘necking’ would make the foiling process difficult, or at least wasteful of foil. Aptly, the carrier layer has at least one substantially flat surface for a heat reflective layer to be efficiently located and adhered to to thereby provide at least one substantially flat heat reflective outwardly facing surface to the device.

Aptly, the carrier layer 110 is substantially hydrophobic such that it does not absorb moisture during the tumble drying process which may otherwise compromise the integrity and shape of the device in use and prevent the same from being reused. The adhesive that is absorbed into the carrier layer material contributes to the hydrophobic nature of the device once the adhesive is dry. Alternatively, the carrier layer 110 may be substantially hydrophilic whilst being sufficiently sealed in a hydrophobic material, such as an adhesive containing a water proofing agent or wax, to ensure the carrier layer is water resistant and its integrity is not compromised during use. The carrier layer 110 may be a single layer of the same material, a layer of more than one material, or a plurality of layers of the same materials or a composite of different materials.

The adhesive is aptly a hot-melt adhesive, such as MagnaPrint™ Foil Binder BMS, Magnaprint™ Foil Binder NMP, or the like, which is printable on each surface 112,114 of the carrier layer 110. Aptly, the adhesive is printed on each surface using a 43T mesh screen and around two strokes of an 8 mm diameter metal rod applied at pressure on the screen and driven by a moving magnet to force the adhesive through the screen. The adhesive on the first surface 112 of the carrier layer 110 is applied at a pickup of around 222 gsm and subjected to a temperature of around 150° C. for around 1 minute to dry the first layer of adhesive. The adhesive on the second surface 114 of the carrier layer 110 is applied at a pickup of around 215 gsm and subjected to a temperature of around 150° C. for around 2 minutes to dry and cure the second layer of adhesive. A suitable temperature range is around 140-165° C. but other temperatures and drying times may be suitable, such as 250° C. for 30 seconds depending on the material of the substrate 110 and/or type of adhesive used. The pickup is the weight of the wet adhesive per unit area of measurement, e.g. 1 square metre of the carrier layer would have 222 g of wet adhesive applied evenly thereto. If a one-sided sheet is desirable, the side supporting the heat reflective layer is coated with adhesive first before the second side of the carrier layer is optionally coated with adhesive to provide some water resistance particularly if the carrier layer material is substantially water absorbent. A suitable printing machine for applying the adhesive to the carrier layer/s 110 is a Johannes Zimmer MDF.R.255 1983 printing machine.

The heat reflective layer/s 120,122 are each aptly a relatively thin layer, aptly around 0.02 mm thick, of a metallic material, such as a metal, metal alloy or metal oxide. The heat reflective layer/s may be silver, gold and/or aluminium or the like, and may be the same material or different materials. Aptly, alloys/mixtures of aluminium may be used. The outer surface of the heat reflective layer/s is aptly silver, gold, amber-gold, copper, bronze, or the like, in colour. A lacquer may be used to protect the outer surface of the heat reflective layer and to provide the colour thereof. The heat reflective layer/s 120,122 are aptly applied to the dry adhesive 115 previously applied on each surface of the substrate by heating to around 150° C. for around 12 seconds at a pressure of around 5.2 kg/m². The reheating of the dry adhesive layer/s activates the hot melt adhesive component enabling the foil to be adhered to it. The coated substrate/carrier layer 110 is then allowed to cool to room temperature and an optional release layer of, for example, 12 μm PET material is peeled off, leaving the foil layer on the substrate. The release layer protects the foil layer before and during application and also assists the application of the foil layer onto the substrate. A wax or silicon may be used between the foil layer and the release layer to allow the same to be efficiently removed from the foil layer.

The foil pickup, i.e. weight of foil added to the carrier layer and adhesive assembly, is around 3 gsm. A suitable machine for applying the heat reflective layer/s to the carrier/substrate layer is an Insta Heat Seal Machine model no. 718. Other suitable application methods include dry coating such as block printing, electrochemical coating such as anodization, wet coating such as printing, powder coating, or the like.

The device 100 may be any suitable shape such as substantially square, rectangle, triangular, hexagonal, circular, oval, or the like. A substantially polygonal shape ensures any waste material, and time and energy used, when cutting each device from a relatively large sheet during manufacture is kept to a minimum. Aptly, the device is substantially square in sheet profile. Aptly, the sheet device has a width/length/diameter of around 50 mm to around 300 mm and a single side of the device may have a surface area of at least around 6000 mm², and aptly from around 6000 mm2 to around 65000 mm².

Aptly, the carrier layer 110 has a thickness of from around 0.03 mm to around 1.5 mm mm. Aptly, each of the heat reflective layers 120,122 has a thickness of from around 0.01 mm to around 0.5 mm. The heat reflective layers may have the same or different thicknesses. Aptly, the device 100 has a total thickness of greater than 0.05 mm, and aptly from around 0.1 mm to around 1.5 mm, preferably from around 0.2 to around 0.5 mm.

Optionally, the device 100 is substantially resistant/resilient to permanent crumpling, i.e. permanently bending, curling, folding, or the like, during use in a tumble drying process such that the device does not permanently curl, roll up, e.g. into a tube or ball, and/or fail or fracture in use. Aptly, the device, particularly the carrier layer, may be at least partially elastic. Aptly the device may have a bending stiffness/flexural rigidity which is sufficient to withstand the loading subjected to the device by the weight and movement of at least one textile article during a drying cycle in a clothes dryer whilst substantially retaining its original shape during the drying cycle. The device 100 may have an overall bending stiffness which allows it to at least partially maintain its original shape whilst not essentially having to be perfectly elastic. Aptly, the carrier layer has sufficient dimensional stability and flat surfaces for efficient receipt of a foil layer during the manufacturing process, and to efficiently and consistently provide maximum surface area for reflecting heat in use.

Aptly, the device 100 according to certain embodiments of the present invention is relatively lightweight, such as from around 1 g to around 20 g, and aptly between around 2.5 g and around 10 g, to further reduce/eliminate the risk of damage to the dryer and article/s being dried and to further ensure the level of noise created by the dryer when in use is not increased by the addition of the device.

The device 100 may include an interior region in which an active ingredient, e.g. a perfume, powder/liquid softener, or the like, may be located before the device is placed into a clothes dryer. The device 100 may be substantially sachet-like comprising two or more sheets adhered together at edge regions to provide access to an interior region via an opening between the layers. Alternatively, a pouch or the like may be provided in a surface of the device which may be closable/sealable after an active ingredient has been placed therein.

A number of tests were performed by the applicant using a conventional washing machine, a conventional tumble dryer, 2 kg white cotton cut into 4×500 g pieces, drying aid sample under test, and a balance for weighing the test specimens. Each test was repeated at least ten times, aptly around twenty times, and the mean result was recorded. The total weight of the interlocked cotton sheets was first recorded before the sheets were placed into the washing machine. A 30-minute cold wash cycle was carried out including a 1200 speed spin cycle with no additions to the machine. The damp sheets were immediately removed from the washing machine and the ‘after-washing’ total weight was recorded. The damp sheets were then placed in the tumble dryer and subjected to a drying cycle of 60 minutes. The sheets were then immediately removed from the tumble dryer and the ‘after-drying’ total weight was recorded. The remaining moisture content (RMC) was calculated as a percentage using the following equation:

$$\frac{final weight of damp fabric - weight of dry fabric}{original weight of damp fabric - weight of dry fabric} \times 100$$

The damp sheets were then returned to the tumble dryer until completely dry for re-use in a subsequent test.

The results for different forms of test specimen in accordance with certain embodiments of the present invention are shown in Tables 1 and 2.

As shown in Table 1, a first set of tests was carried out using test specimens which were all substantially sheet-like and had the same profile dimensions of 107 mm×107 mm square whilst having different make-ups and/or thicknesses. In comparison with a control (2 kg white cotton load only), it can be seen that including a sheet of conventional baking tin foil having a thickness of 0.01 mm has a significant detrimental effect on the drying performance of the tumble dryer. Likewise, an acrylic sheet having a thickness of 0.5 mm has negligible effect on the drying performance of the tumble dryer.

In accordance with certain embodiments of the present invention, a 0.4 mm thick sheet (sheet 1) consisting of 80 gsm of PET needle-punch non-woven fabric and a layer of aluminium foil on one side thereof has an increased drying performance of 17% when compared to the control. A 0.4 mm thick sheet (sheet 2) consisting of 80 gsm of PET needle-punch non-woven fabric and a layer of aluminium foil on both sides thereof has an increased drying performance of 40% when compared to the control. A 0.21 mm thick sheet (sheet 3) consisting of 60 gsm of cellulose-based wet laid non-woven fabric and a layer of aluminium foil on one side thereof has an increased drying performance of 27% when compared to the control. A 0.21 mm thick sheet (sheet 4) consisting of 60 gsm of cellulose-based wet laid non-woven fabric and a layer of aluminium foil on both sides thereof has an increased drying performance of 33% when compared to the control. A 1.05 mm thick sheet (sheet 5) consisting of two layers of 120 gsm PET needle punch non-woven fabric and a layer of aluminium foil on both sides thereof has an increased drying performance of 7% when compared to the control.

Further tests were carried out as shown in Table 2 using further test specimens which were all substantially sheet-like, having a thickness of 0.4 mm, and consisting of an 80 gsm PET needle punch non-woven carrier layer and an aluminium foil on both sides thereof, whilst having different profile dimensions and in turn different surface areas. In accordance with certain embodiments of the present invention, a 30×30 mm sheet (sheet 6) consisting of 80 gsm of PET needle-punch non-woven fabric and a layer of aluminium foil on both sides thereof has a −15% detrimental effect on the drying performance when compared to the control. A 30×120 mm sheet (sheet 7) consisting of 80 gsm of PET needle-punch non-woven fabric and a layer of aluminium foil on both sides thereof has a −27% detrimental effect on the drying performance when compared to the control. A 90×75 mm sheet (sheet 8) consisting of 80 gsm of PET needle-punch non-woven fabric and a layer of aluminium foil on both sides thereof has a −7% detrimental effect on the drying performance when compared to the control. An 82×82 mm sheet (sheet 9) consisting of 80 gsm of PET needle-punch non-woven fabric and a layer of aluminium foil on both sides thereof has an increased drying performance of 20% when compared to the control. A 90×90 mm sheet (sheet 10) consisting of 80 gsm of PET needle-punch non-woven fabric and a layer of aluminium foil on both sides thereof has an increased drying performance of 37% when compared to the control. A 210×297 mm sheet (sheet 11) consisting of 80 gsm of PET needle-punch non-woven fabric and a layer of aluminium foil on both sides thereof has an increased drying performance of 13% when compared to the control.

As such, in accordance with certain embodiments of the present invention, a device comprising a substrate having at least one heat reflective layer located thereon and having a total thickness of greater than 0.05 mm, and aptly from around 0.1 mm to around 1.5 mm, and suitably from around 0.2 to around 0.5 mm, has a significantly improved and desirable effect on the drying performance of the tumble dryer.

As illustrated in Tables 1 and 2, aptly the device 100 has a carrier layer 110 of 80 gsm PET needle-punch non-woven fabric which has a layer of aluminium foil 120,122 adhered to both of its surfaces 112,114. Preferably, the total thickness of the sheet is around 0.15-0.5 mm, and aptly around 0.4 mm. Preferably, the sheet is substantially square having dimensions of around 107×107 mm. Preferably, each outer surface of the sheet has a surface area of around 11450 mm². Preferably, the sheet weighs around 3.3 g.

Certain embodiments of the present invention therefore provide a device, use and method that substantially increases the efficiency and performance of a clothes drying process by a clothes dryer in terms of time and energy, without imparting chemicals or deposits onto the textile article being dried and/or into the atmosphere during the drying process. The amount of time and energy required for a domestic or industrial dryer to dry a textile material is desirably reduced. The device may be re-usable which saves on material, waste, cost and energy, and one or more device may be used in a single drying cycle depending on the desired drying performance and/or the amount/characteristics of the textile article/s to be dried. The device may be selectively used when, for example, items of dry clothing are required quickly, or for a family with many loads of laundry. Recent concerns about tumble dryers causing fires mean consumers wait at home for the tumble dryer to finish and they choose not to operate the tumble dryer at night. These changes in behaviour require shorter drying times. Shorter tumbling times results in less fibre damage which prolongs the life of a textile article and of the tumble dryer itself. Furthermore, laundry can be dried at a lower temperature setting again causing less fibre damage and prolonging life of tumble dryer heater, whilst using less energy. The device also reduces static electricity build up on textiles being tumbled and softens the fabric. The device does not use a chemical and therefore does not impart a chemical residue on to the textile item and is environmentally friendly.

1-26. (canceled)

27. A heat reflective sheet to improve the drying performance of a tumble dryer, the heat reflective sheet comprising:
a substantially sheet-like substrate having a first outer surface and an opposed second outer surface; and
a heat reflective layer located on each of the first and second outer surfaces of the substrate.

28. The heat reflective sheet as claimed in claim 27, having a thickness of at least 0.05 mm.

29. The heat reflective sheet as claimed in claim 28, wherein the thickness is between 0.1 mm and 1.5 mm.

30. The heat reflective sheet as claimed in claim 27, wherein each heat reflective layer has a thickness of 0.01 mm to 0.5 mm.

31. The heat reflective sheet as claimed in claim 27, wherein each heat reflective layer has a surface area of at least 6000 mm².

32. The heat reflective sheet as claimed in claim 31, having a maximum dimension across its profile of 300 mm.

33. The heat reflective sheet as claimed in claim 27, wherein the substrate comprises at least one layer of a non-woven material.

34. The heat reflective sheet as claimed in claim 33, wherein the non-woven material comprises at least one of polyethylene terephthalate or cellulose.

35. The heat reflective sheet as claimed in claim 27, wherein the substrate has a weight of 40 to 120 gsm.

36. The heat reflective sheet as claimed in claim 35, wherein the substrate has a weight of 80 gsm.

37. The heat reflective sheet as claimed in claim 27, wherein each heat reflective layer comprises a metallic material.

38. The heat reflective sheet as claimed in claim 37, wherein each heat reflective layer comprises aluminium.

39. The heat reflective sheet as claimed in claim 38, wherein each heat reflective layer comprises a layer of gold aluminium foil.

40. The heat reflective sheet as claimed in claim 27, wherein each heat reflective layer is adhered to the substrate by an adhesive.

41. The heat reflective sheet as claimed in claim 27, having a substantially polygonal or curved peripheral profile.

42. Use of a heat reflective sheet as claimed in claim 27 to improve the drying performance of a tumble dryer.

43. A method of manufacturing a heat reflective sheet to improve the drying performance of a tumble dryer, the method comprising the steps of:
providing a substantially sheet-like substrate having a first outer surface and an opposed second outer surface; and
locating a heat reflective layer on each of the first and second outer surfaces of the substrate.

44. The method as claimed in claim 43, further comprising the step of applying an adhesive to the first and second outer surfaces of the substrate prior to locating each heat reflective layer thereon.

45. The method as claimed in claim 44, further comprising the step of curing the adhesive at a predetermined temperature for a predetermined time.

46. The method as claimed in claim 43, wherein a thickness of the heat reflective sheet is at least 0.05 mm.

47. The method as claimed in claim 43, further comprising the step of providing the heat reflective sheet with a substantially polygonal or curved peripheral profile.

48. The method as claimed in claim 43, wherein the substrate comprises a non-woven material.

49. The method as claimed in claim 48, wherein the non-woven material comprises at least one of polyethylene terephthalate or cellulose.

50. The method as claimed in claim 43, wherein each heat reflective layer comprises a metallic material.
